(19) United States
(12) Patent Application Publication
(10) Pub. No.: US 2009/0225541 A1
(43) Pub. Date: Sep. 10, 2009

(54) LUMINOUS DEVICE MOUNTING SUBSTRATE, LUMINOUS DEVICE MOUNTING PACKAGE, AND PLANAR LIGHT SOURCE DEVICE

(75) Inventors: Shuji Gomi, Chiba (JP); Kenji Shinozaki, Chiba (JP); Shuichi Naijo, Chiba (JP); Takeo Watanabe, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/090,725

(22) PCT Filed: Oct. 16, 2006
(86) PCT No.: PCT/JP2006/320992

§ 371 Date: Apr. 18, 2008

Related U.S. Application Data
(60) Provisional application No. 60/731,494, filed on Oct. 31, 2005.

(30) Foreign Application Priority Data
Oct. 20, 2005 (JP) 2005-306051

(51) Int. Cl. F21V 9/00

(52) U.S. Cl. 362/231

(57) ABSTRACT

The luminous device mounting substrate, in which plural kinds of luminous devices with different luminance colors are mounted, is characterized by comprising a plurality of luminous device mounting portions each of which is for enclosing a luminous device corresponding to a luminance color, wherein the luminous device mounting portion has a configuration in which a plurality of luminous devices can be mounted on each luminous device mounting portion.

### CROSS REFERENCES OF RELATED APPLICATION

This application is an application filed under 35 U.S.C. §111(a) claiming benefit pursuant to 35 U.S.C. §119(e) (1) of the filing date of Provisional Application 60/731,494 filed on Oct. 31, 2005 pursuant to 35 U.S.C. §111(b).

### TECHNICAL FIELD

The present invention relates to a luminous device mounting substrate, a luminous device mounting package, and a planar light source device using them for mounting a luminous device useful as an illumination and an illuminant of a back light for a liquid crystal.

More specifically, the present invention relates to a luminous device mounting substrate that is useful for mounting a plurality of luminous devices with different luminance colors that are useful as a white color illuminant, a luminous device mounting package, and a planar light source device using them.

### BACKGROUND ART

In recent years, a luminous efficiency of a luminous device has been extremely improved, and an application of the luminous device to an illumination is being progressed.

In particular, in the case in which there is used a light emitting diode (hereafter also referred to as LED) that is one of solid state luminous devices as a back light illuminant (surface light source) for a liquid crystal display, an excellent color reproducibility and a high speed response can be implemented and it is expected that a high quality display be achieved.

Conventionally, the main stream of such a back light illuminant for a liquid crystal display has been the so-called edge light type in which a cold cathode tube as an illuminant is disposed on the edge face of the chassis for thinning and low power consumption of the apparatus.

However, in recent years, a demand of enlarging a liquid crystal display has been increased, and the edge light type has a limitation in improving luminance and uniformity in the luminance.

Therefore, an adoption of a direct lighting type light is examined for a large size liquid crystal display.

In addition, since a demand of improving the quality of a display is increased, an excellent color reproducibility cannot be implemented in the case in which there is used a white color light emitting diode (LED) utilizing complementary colors of a light emission of a blue color light emitting diode and a light emission of a yellow color fluorescent substance.

Under such a background, recently, there has been developed an LED lamp of the so-called three-in one package, in which light emitting diode (LED) chips of three primary colors composed of red, green, and blue are disposed in one package and a white color is generated by mixing these colors (for instance, see Non Patent Document 1 (the website of STANLEY ELECTRIC CO., LTD.)).

As shown in FIG. 9, such a three-in one package 100 has an outline of several mm square and a configuration in which an LED chip generating red 102, an LED chip generating green 104, and an LED chip generating blue 106 each of approximately 0.35 mm square are adjacently disposed at the positions corresponding to vertexes of an equilateral triangle, respectively, at the center of the package.

An advantage of an LED lamp (illuminant) of the three-in one type is that a white color light can be easily obtained by mixing three colors. Consequently, the above described three-in one package 100 is utilized. Non Patent Document 1: The website of STANLEY ELECTRIC CO., LTD., [online], internet <http://www.stanley-components.com>

### DISCLOSURE OF THE INVENTION

### Problems to be Solved by the Invention

However, since three LED chips 102, 104, and 106 must be adjacently disposed to obtain an excellent white color by mixing colors, there is a disadvantage with respect to heat radiation.

This is a serious problem particularly in the case in which the so-called high power LED with an LED chip size of 1 mm square or larger is used in particular.

Consequently, each of three-in one packages 100 with a different distance between LED chips must be prepared according to a size of an LED chip to be used.

In the case in which the three-in one package is used as a back light illuminant for a liquid crystal display, if a screen size is enlarged, mixing of three colors is made easier as compared to the case of a small size screen, and a white color illuminant can be obtained on a back light surface even in the case in which a distance between LED chips of three colors is enlarged.

Accordingly, in order to effectively utilize such a condition, a three-in one package 100 with a large distance between LED chips must be separately produced.

In addition, a conventional LED lamp of a three-in one type has a configuration in which each of LED devices of three colors is just formed adjacently to each other in one three-in one package 100, thereby causing a low power and a low luminance. In order to make a high luminance to appear, many three-in one packages 100 must be arranged in an array pattern.

An object of the present invention is to produce a luminous device mounting package containing an illuminant with different distances between luminous devices in one kind of package. Another object of the present invention is to provide a luminous device mounting substrate, a luminous device mounting package, and a planar light source device using them that can implement a cost reduction for producing and mounting a luminous device mounting package.

### Means for Solving the Problems

The present inventors found out a luminous device mounting substrate, a luminous device mounting package, and a planar light source device using them in order to solve the above problems.

More specifically, the present invention involves the following embodiments (1) to (16) for instance.

(1) The luminous device mounting substrate, in which plural kinds of luminous devices with different luminance colors are mounted, comprising a plurality of luminous device mounting portions each of which is for enclosing a luminous device corresponding to a luminance color, wherein the luminous device mounting portion has a configuration in which a plurality of luminous devices can be mounted on each luminous device mounting portion.
(2) A luminous device mounting substrate as defined in above (1), wherein the number of the luminous device mounting portions that are formed is equivalent to or larger than the number of different luminance colors of the luminous devices to be mounted.
(3) A luminous device mounting substrate as defined in above (1) or (2), wherein the luminous device mounting portions are disposed at a constant pitch on the luminous device mounting substrate.
(4) A luminous device mounting substrate as defined in above (2), wherein a plurality of the luminous device mounting portions is formed in an extending manner from a fixed point on the luminous device mounting substrate toward a circumference of a circle in which the fixed point is the center, and is disposed apart at the specified angle.
(5) A luminous device mounting substrate as defined in above (2), wherein the luminous device mounting portions are disposed in such a manner that a side of an equilateral polygon in which the fixed point of the luminous device mounting substrate is the center of gravity almost conforms with a line in a longitudinal direction of the luminous device mounting portion.
(6) A luminous device mounting substrate as defined in above (4) or (5), wherein the fixed point is the center of the luminous device mounting substrate.
(7) A luminous device mounting substrate as defined in above (4) or (5), further comprising a plurality of the fixed points.
(8) A luminous device mounting substrate as defined in any one of above (1) to (7), further comprising a protrusion at the position where the luminous device mounting portion is disposed on the luminous device mounting substrate, wherein the luminous device mounting portion is disposed on the protrusion.
(9) A luminous device mounting substrate as defined in above (8), wherein the protrusion is made of a material equivalent to that of the luminous device mounting substrate.
(10) A luminous device mounting substrate as defined in any one of above (1) to (9), wherein the luminous device mounting substrate is a metal base substrate.
(11) A luminous device mounting substrate as defined in any one of above (1) to (10), wherein the luminous device is a light emitting diode (LED).
(12) A luminous device mounting substrate as defined in above (11), wherein the light emitting diode (LED) is a light emitting diode (LED) chip.
(13) A luminous device mounting substrate as defined in above (12), further comprising substrate electrode pads, which are connected by wire bonding to an anode and a cathode of the light emitting diode (LED) chip, on the both sides of the luminous device mounting portion.
(14) A luminous device mounting package, comprising a reflector provided with an opening portion at a position corresponding to the luminous device mounting portion on the luminous device mounting substrate as defined in any one of above (1) to (13).
(15) A luminous device mounting package as defined in above (14), wherein the opening portion is buried by a sealing resin in such a manner that the top of the opening portion becomes almost flat at the same height as the surface of the reflector.
(16) A planar light source device, wherein a luminous device mounting package as defined in above (14) or (15) is installed on the bottom face of the chassis.

### EFFECT OF THE INVENTION

A luminous device mounting substrate according to the present invention can have a configuration in which luminous devices having different luminance colors can be mounted while modifying a distance between adjacent luminous devices. Therefore, since luminous devices with different sizes or different calorific values can be mounted in one kind of luminous device mounting package, it is not necessary to design and produce many kinds of luminous device mounting substrates and luminous device mounting packages, thereby reducing a cost.

Moreover, plural sets of luminous devices can also be mounted on one luminous device mounting substrate or in one luminous device mounting package, thereby making a high luminance to appear.

Consequently, a high performance planar light source device can be obtained at a low cost by using the luminous device mounting package according to the present invention.

### BRIEF DESCRIPTION OF THE DRAWINGS

FIG. 1 is a schematic plan view showing a first embodiment related to a luminous device mounting substrate according to the present invention.

FIG. 2 is a schematic cross-sectional view showing a luminous device mounting substrate along with an X-X line in FIG. 1.

FIG. 3 is a schematic plan view showing a package in which a set of LED chips is mounted on a luminous device mounting substrate shown in FIG. 1.

FIG. 4 is a schematic cross-sectional view for showing a package shown in FIG. 3.

FIG. 5 is a schematic plan view showing a package in which three sets of LED chips are mounted on a luminous device mounting substrate shown in FIG. 1.

FIG. 6 is a schematic cross-sectional view for showing a package shown in FIG. 5.

FIG. 7 is a schematic plan view showing a second embodiment related to a luminous device mounting substrate according to the present invention similarly to FIG. 2.

FIG. 8 is a schematic plan view showing a third embodiment related to a luminous device mounting substrate according to the present invention.

FIG. 9 is a schematic plan view showing a conventional three-in one package.

### BEST MODE OF CARRYING OUT THE INVENTION

An embodiment (example) of the present invention will be described below in detail with reference to the drawings.

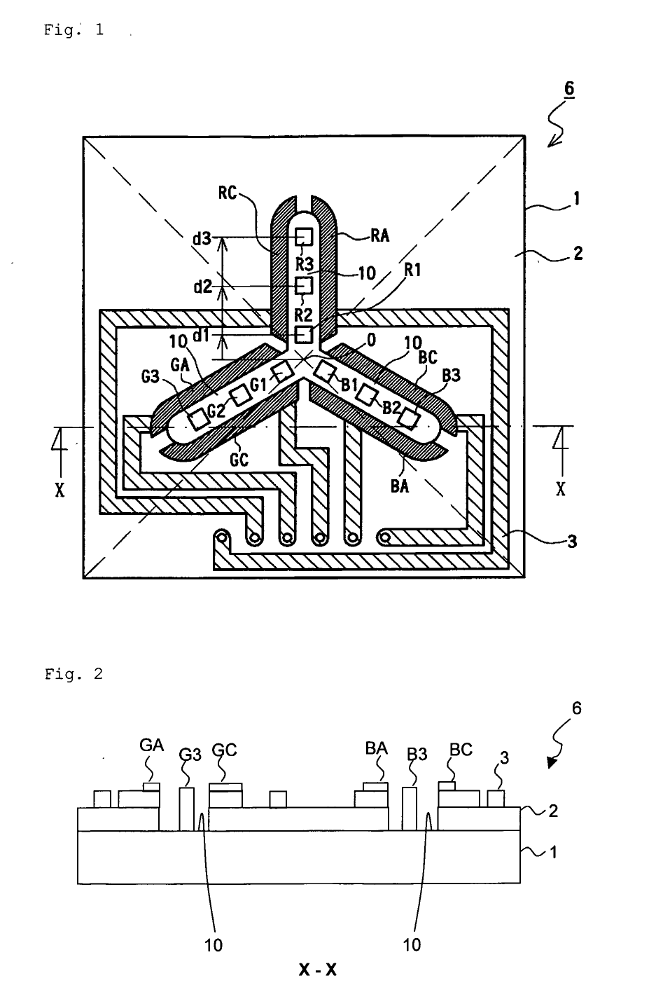

FIG. 1 is a schematic plan view showing a first embodiment related to a luminous device mounting substrate according to the present invention.

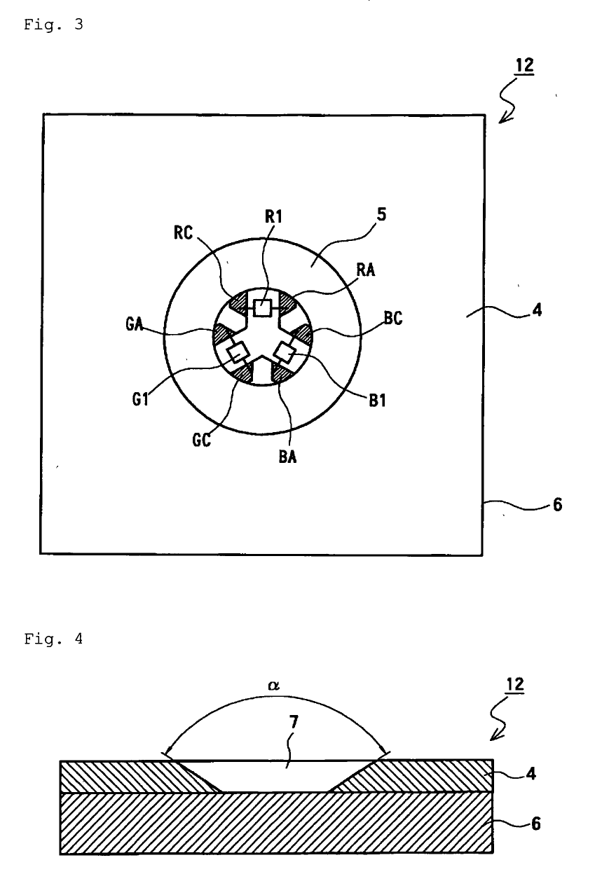

FIG. 2 is a schematic cross-sectional view showing a luminous device mounting substrate along with an X-X line in FIG. 1.

The present embodiment as shown in FIG. 1 has a configuration in which an LED chip R emitting a red light, an LED chip G emitting a green light, and an LED chip B emitting a blue light are used, luminous device mounting portions 10 are formed in an extending manner in three directions from a fixed point O on a luminous device mounting substrate 1 toward a circumference in which the fixed point O is the center, and the three LED chips R, G, and B, respectively, can be mounted on each of the luminous device mounting portions 10.

The above entire configuration is named a mounting substrate unit 6.

More specifically, the mounting substrate unit 6 has a configuration in which two straight lines passing through the center section of the adjacent luminous device mounting portions 10 make an angle of approximately 120 degrees (360/3 degrees) in the case in which straight lines are drawn passing through the center section in a longitudinal direction of the three luminous device mounting portions 10 while using the center O on the luminous device mounting substrate 1 as a base point.

The approximately 120 degrees mean that it is not necessary to be strictly 120 degrees and a minute difference is allowed. It is preferable that a difference is within 1/10 of an angle to be made.

In the following descriptions, a number is added as a suffix letter to an LED chip R emitting a red light, an LED chip G emitting a green light, and an LED chip B emitting a blue light in the case in which a plurality of LED chips is identified.

More specifically, LED chips R1, G1, and B1 can be mounted at positions of a distance d1 from the center O on the luminous device mounting substrate 1, LED chips R2, G2, and B2 at positions of a distance d2, and LED chips R3, G3, and B3 at positions of a distance d3.

That is to say, the present invention can be applied to three kinds of configurations with different distances between LED chips.

In the embodiment shown in FIG. 1, d1 is smaller than d2, and d2 is smaller than d3.

An LED chip is bonded through a paste or radiating grease to a metal base substrate or a metal foil made of copper or aluminum having excellent thermal conductivity as a substrate in such a manner that the heat of an LED chip is externally radiated excellently.

The substrate electrode pads (anode A and cathode C) that are electrically connected to electrodes (anode and cathode) of LED chips (not shown) by wire bonding are disposed on the both sides of each of the luminous device mounting portions 10 on the luminous device mounting substrate 1.

The electrode pads RA, RC, GA, GC, BA, and BC for each of colors are electrically connected to substrate wirings 3 for supplying an electric current thereto.

As shown in FIG. 2, an insulating layer 2 is formed on the surface of the luminous device mounting substrate 1 except for a region on which an LED chip is mounted, and a substrate wiring 3 made of copper or the like is formed on the insulating layer 2. An insulating layer 2 can be further formed on the substrate wirings 3 except for a region of the substrate electrode pads in such a manner that the surface of the substrate electrode pads and the surface of the insulating layer 2 are made almost flat at the same height although this is not shown in the figure.

As described above, an electrode of an LED chip and a substrate electrode pad are connected to each other by wire bonding (not shown).

In the case in which a gold wire is used as a bonding wire, a gold plating layer is formed on the surface of an electrode of an LED chip and the surface of a substrate electrode pad to obtain an excellent connection.

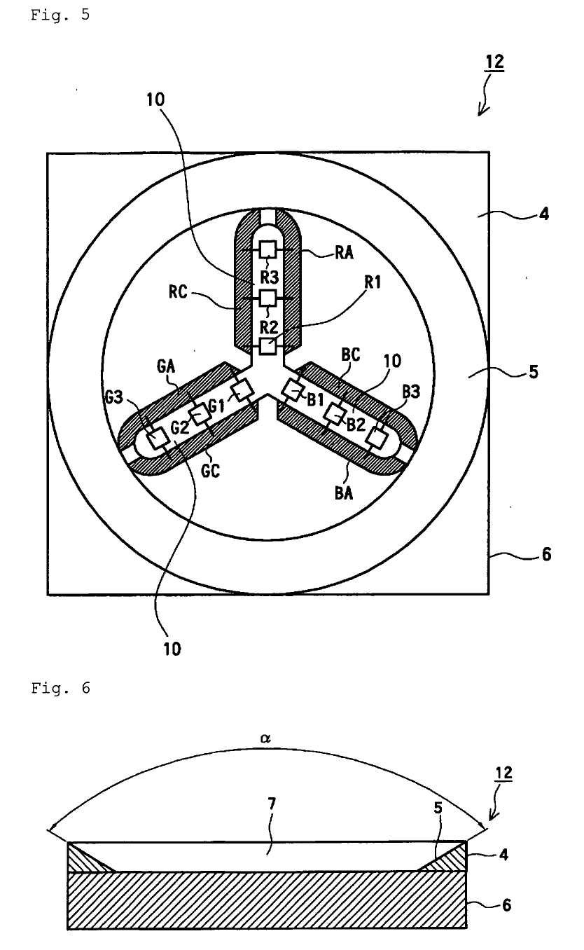

FIGS. 3 and 4 are a schematic plan view and a schematic cross-sectional view, respectively, showing a luminous device mounting package 12 in the case in which a set of LED chips R1, G1, and B1 is mounted only at positions of distance d1 from the center O on the luminous device mounting substrate 1 (mounting substrate unit 6).

The luminous device mounting package 12 shown in FIG. 3 incorporates LED chips of only R1, G1, and B1, and a reflector 4 provided with an opening portion is formed on the luminous device mounting substrate 1 (mounting substrate unit 6) in such a manner that the reflector covers the periphery of the LED chips to effectively reflect lights emitted from the LED chips upward from the luminous device mounting substrate 1.

Such a reflector 4 is bonded to the surface of the mounting substrate unit 6 preferably through an adhesive.

Consequently, in the luminous device mounting package 12 shown in FIG. 3, an exterior region surrounding a region on which the LED chips R1, G1, and B1 are mounted are covered with the reflector 4, and other wiring patterns on the surface of the mounting substrate unit 6 are invisible.

Wire bonding causes electrode pads (not shown) mounted on the LED chips R1, G1, and B1 and substrate electrode pads around them to be connected to each other.

In the case in which there is used an LED chip with a small size, as shown in FIG. 3, LED chips of each of colors can be adjacently mounted at a position of a small distance from the substrate center O to advantageously uniform chromaticity.

As an LED chip size is larger, an amount of heat radiation accompanying a light emission is increased.

Consequently, in the case in which there is used an LED chip with a large size, the LED chip can be mounted at a position of a larger distance from the center O on the luminous device mounting substrate 1 (mounting substrate unit 6).

As described above, corresponding to a size of an LED chip and an amount of heat radiation, a mounting position of an LED chip can be properly modified in one luminous device mounting package.

A distance between substrate electrode (anode and cathode) pads is made larger than a width of a luminous device region formed in such a manner that the largest LED chip to be applied can be mounted.

In a luminous device mounting package 12 shown in FIGS. 5 and 6, LED chips are mounted at all positions of distances d1, d2, and d3 from the center O on the luminous device mounting substrate 1 (mounting substrate unit 6).

By the above configuration, a luminance as an LED lamp can be enlarged.

In such a case, there is formed a reflector 4 provided with a circular opening portion for excellently reflecting lights emitted from the LED chips upward from the luminous device mounting substrate 1 in such a manner that the reflector covers the outside of the distance d3 from the substrate center O on the mounting substrate unit 6.

Wire bonding causes electrode pads (not shown) mounted on the LED chips R1, G1, B1, R2, G2, B2, R3, G3, and B3 and substrate electrode pads around them to be connected to each other.

LED chips with the same luminance color are preferably mounted on one luminous device mounting portion 10. More specifically, it is preferable that LED chips R1, R2, and R3 are mounted on a first luminous device mounting portion, LED chips G1, G2, and G3 are mounted on a second luminous device mounting portion, LED chips B1, B2, and B3 are mounted on a third luminous device mounting portion, and electrode pads of LED chips with the same luminance color are connected to a single electrode pad formed on the both sides of the luminous device mounting portion by wire bonding.

Even in the case in which LED chips have the same shape, driving currents are different depending on a luminance color. Therefore, in the case in which LED chips with the same luminance color are mounted on one luminous device mounting portion 10, a general control of LED chips is easy.

However, a configuration other than the above one is not excluded from the present invention.

Although a material of the reflector 4 to be used is not restricted in particular, a material with an excellent reflectivity such as an aluminum material can be preferably applied.

An inside face 5 of the opening portion of the reflector 4 is processed in a tapered shape (slant face) and has a function to effectively reflect lights emitted from the LED chips upward from the luminous device mounting substrate 1 (mounting substrate unit 6). An angle α of the extended line of the inside face 5 can be preferably 90 to 120 degrees.

The opening portion of the reflector 4 is buried by a sealing resin 7 such as a silicone resin in such a manner that the top of the opening portion becomes almost flat at the same height as the upper surface of the reflector 4, thereby protecting bonding wires. The “almost flat” means that it is not necessary to make the both upper surfaces to be strictly the same face but a few irregularities and a little external waviness can be allowed.

Although LED chips are mounted at all positions of distances d1, d2, and d3 from the center O on the luminous device mounting substrate 1 (mounting substrate unit 6) in the luminous device mounting package 12 shown in FIG. 5, LED chips can also be mounted at positions of only distances d1 and d2, distances d1 and d3, or distances d2 and d3.

While the present embodiment illustrates the case in which luminous device mounting portions are formed at three different positions, the present invention is not restricted to the embodiment, and luminous device mounting portions 10 can also be formed at four positions or more. In addition, while the present embodiment illustrates the case in which each of the luminous device mounting portions is formed with approximately the same width from the center of the substrate in a direction of a circumference in which the substrate center is the center of the circle, each of the luminous device mounting portions can also be formed in such a manner that a width becomes wider as the luminous device mounting portion becomes closer to the circumference.

In addition, while up to three LED chips can be mounted on one luminous device mounting portion 10 in the present embodiment, the present invention is not restricted to the embodiment. A position in which an LED chip of each color is mounted and the number of LED chips that can be mounted can be properly selected, and can be modified depending on a luminous device mounting portion.

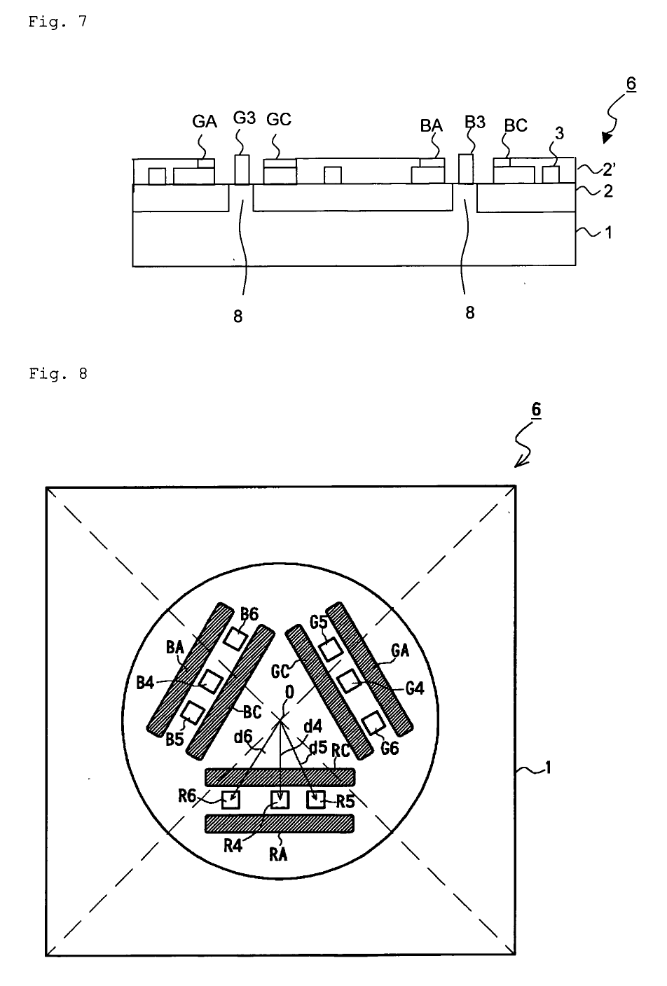

FIG. 7 is a schematic plan view showing a luminous device mounting substrate 1 according to a second embodiment related to the present invention.

The configuration of the luminous device mounting substrate 1 shown in FIG. 7 is basically the same as that of the luminous device mounting substrate 1 according to the first embodiment shown in FIG. 2. Consequently, elements equivalent to those shown in FIG. 2 are numerically numbered similarly and the detailed descriptions of the equivalent elements are omitted.

The difference from the above described first embodiment is that a protrusion 8 is formed on a region of a metal base substrate 1 on which an LED chip is mounted.

The protrusion 8 is made of a metal such as copper and aluminum or a ceramic material such as aluminum nitride, which have excellent thermal conductivity, preferably of the same material as that of the metal base substrate in order to externally radiate the heat of an LED chip through the protrusion 8.

In the present embodiment, a first insulating layer 2 is formed in such a manner that the surface of the protrusion 8 and the surface of the first insulating layer 2 are made almost flat at the same height, and a substrate wiring 3 is formed on the first insulating layer 2.

In addition, a second insulating layer 2′ is formed on the substrate wiring 3 except for a region of the substrate electrode pad in such a manner that the surface of the substrate electrode pad and the surface of the second insulating layer 2′ are made almost flat at the same height.

It is preferable to use a white resist as the second insulating layer 2′ since lights emitted from an LED chip can be effectively reflected upward from the luminous device mounting substrate 1.

A reflector (not shown) is formed on the second insulating layer 2′ and a region of the substrate electrode pad.

Since the surface of the second insulating layer 2′ and the surface of a region of the substrate electrode pad are made almost flat at the same height, there are few gaps between those surfaces and the facing surface of the reflector (not shown), thereby obtaining an excellent adhesion.

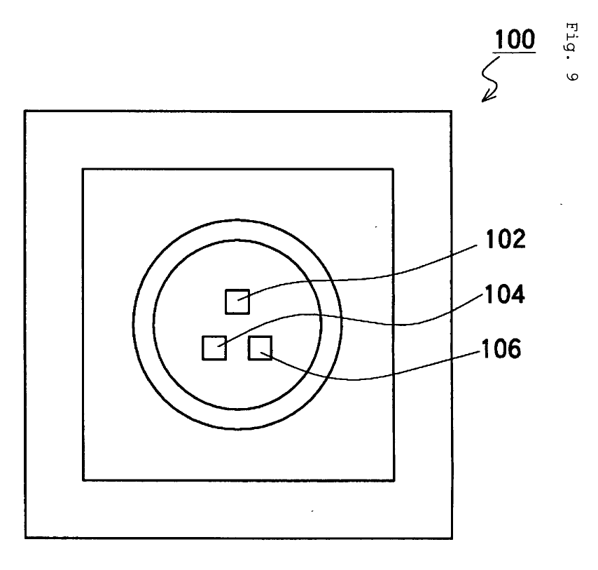

FIG. 8 is a schematic plan view showing a luminous device mounting substrate 1 according to a third embodiment related to the present invention.

The configuration of the luminous device mounting substrate 1 shown in FIG. 8 is basically the same as that of the luminous device mounting substrate 1 according to the first embodiment shown in FIG. 1. Consequently, elements equivalent to those shown in FIG. 1 are numerically numbered similarly and the detailed descriptions of the equivalent elements are omitted.

FIG. 8 shows only the LED chip mounted regions and the substrate electrode pads as a schematic plan view. The present embodiment also illustrates the case in which LED chips of three colors are used.

Each side of an equilateral triangle in which the center O is the center of gravity as the fixed point of the luminous device mounting substrate 1 is almost superposed on a straight line drawn passing through the center section in a longitudinal direction of the luminous device mounting portions 10 on which three LED chip can be mounted between a pair of facing substrate electrode pads. The “almost superposed” means that it is not necessary to be strictly superposed but a few inclinations and displacements can be allowed.

More specifically, LED chips R4, G4, and B4 can be mounted at positions of a distance d4 from the center O on the luminous device mounting substrate 1, LED chips R5, G5, and B5 at positions of a distance d5, and LED chips R6, G6, and B6 at positions of a distance d6.

That is to say, the present invention can be applied to three kinds of configurations with different distances between LED chips.

In the embodiment shown in FIG. 8, d4 is smaller than d5, and d5 is smaller than d6.

Similarly to the first embodiment, LED chips can be mounted on only one set of LED chip mounted regions, or on two or three sets of LED chip mounted regions.

Moreover, a position in which an LED chip of each color is mounted and the number of LED chips to be mounted can be modified depending on a luminous device mounting portion.

While the above described first to third embodiments illustrate the case in which LED chips of three colors are used, LED chips of four colors or more can also be used.

In the case in which LED chips of four colors are used, an olive color is preferably used as the fourth color since it has a color rendering effect.

In the case in which n colors (n is equivalent to or larger than four) are used in a similar configuration to the first and second embodiments, a plurality of LED chips can be mounted in n directions from the center O on the luminous device mounting substrate 1 (adjacent straight lines of two of the n directions make an angle of approximately 360/n degrees).

More specifically, in the case in which four colors are used, two straight lines passing through the center section of the adjacent luminous device mounting portions make an angle of approximately 90 degrees.

In the case in which n colors (n is equivalent to or larger than four) are used in a similar configuration to the third embodiment, there can be formed luminous device mounting portions on which a plurality of LED chips can be mounted on each side of an equilateral polygon with n sides in which the center O on the luminous device mounting substrate 1 is the center of gravity.

While the above embodiments illustrate the case in which the number of luminance colors is equivalent to the number of luminous device regions, the number of luminous device regions can also be larger than the number of luminance colors.

As an example, for three colors of R, G, and B, there can be formed one luminous device region for R, two luminous device regions for G, and one luminous device region for B, that is, the number of luminous device regions is four.

In such a case, the number of luminous device regions and the configuration of electrode pads and so on can be equivalent to the case of four colors in the above described first to third embodiments.

For a metal base substrate used in the above described first to third embodiments, there is preferably used a printed wiring board containing a metal plate with excellent thermal conductivity as a base.

Although a material and a producing method of the metal base substrate are not restricted in particular, a conventional material and a conventional production technique of a printed wiring board can be directly applied.

The present embodiment was fabricated by using a copper-clad laminate plate in which a glass epoxy material as an insulating layer was laminated on the surface of a copper plate, by processing a copper foil to be a wiring pattern (forming a gold plating layer on the surface of an electrode pad), and by selectively removing an insulating layer on a luminous device mounting portion.

The configuration of a planar light source device using a luminous device mounting package according to the present invention can be similar to that of a conventional planar light source device. More specifically, luminous device mounting packages of the required number according to the present invention can be installed on the bottom face of the chassis made of a material such as aluminum. While each of the first to third embodiments illustrates the case in which the center of the substrate is the fixed point, that is, there is formed one light source unit configuring a white color illuminant by mounting LEDs of a plurality of colors on one substrate, the present invention is not restricted to the embodiments. Instead, there can be adopted the case in which a substrate contains a plurality of fixed points, that is, there is formed a plurality of light source units in one line or in an array pattern, etc. on one large size substrate.

As a planar light source device, for instance, a back light for a liquid crystal display apparatus or an advertising light are mentioned.

While the preferred embodiments of the present invention have been described above, the present invention is not restricted to the embodiments, and various changes, modifications, and functional additions can be thus made without departing from the scope of the present invention. For instance, while a luminous device mounting substrate and a luminous device mounting package according to the present invention are useful for mounting a plurality of luminous devices having different luminance colors, a white color luminous device that does not require mixing of colors can also be mounted.

1. A luminous device mounting substrate, in which plural kinds of luminous devices with different luminance colors are mounted, comprising a plurality of luminous device mounting portions each of which is for enclosing a luminous device corresponding to a luminance color, wherein the luminous device mounting portion has a configuration in which a plurality of luminous devices can be mounted on each luminous device mounting portion.

2. A luminous device mounting substrate as defined in claim 1, wherein the number of the luminous device mounting portions that are formed is equivalent to or larger than the number of different luminance colors of the luminous devices to be mounted.

3. A luminous device mounting substrate as defined in claim 1, wherein the luminous device mounting portions are disposed at a constant pitch on the luminous device mounting substrate.

4. A luminous device mounting substrate as defined in claim 2, wherein a plurality of the luminous device mounting portions is formed in an extending manner from a fixed point on the luminous device mounting substrate toward a circumference of a circle in which the fixed point is the center, and is disposed apart at the specified angle.

5. A luminous device mounting substrate as defined in claim 2, wherein the luminous device mounting portions are disposed in such a manner that a side of an equilateral polygon in which the fixed point of the luminous device mounting substrate is the center of gravity almost conforms with a line in a longitudinal direction of the luminous device mounting portion.

6. A luminous device mounting substrate as defined in claim 4, wherein the fixed point is the center of the luminous device mounting substrate.

7. A luminous device mounting substrate as defined in claim 4, further comprising a plurality of the fixed points.

8. A luminous device mounting substrate as defined in claim 1, further comprising a protrusion at the position where the luminous device mounting portion is disposed on the luminous device mounting substrate, wherein the luminous device mounting portion is disposed on the protrusion.

9. A luminous device mounting substrate as defined in claim 8, wherein the protrusion is made of a material equivalent to that of the luminous device mounting substrate.

10. A luminous device mounting substrate as defined in claim 1, wherein the luminous device mounting substrate is a metal base substrate.

11. A luminous device mounting substrate as defined in claim 1, wherein the luminous device is a light emitting diode (LED).

12. A luminous device mounting substrate as defined in claim 11, wherein the light emitting diode (LED) is a light emitting diode (LED) chip.

13. A luminous device mounting substrate as defined in claim 12, further comprising substrate electrode pads, which are connected by wire bonding to an anode and a cathode of the light emitting diode (LED) chip, on the both sides of the luminous device mounting portion.

14. A luminous device mounting package, comprising a reflector provided with an opening portion at a position corresponding to the luminous device mounting portion on the luminous device mounting substrate as defined in claim 1.

15. A luminous device mounting package as defined in claim 14, wherein the opening portion is buried by a sealing resin in such a manner that the top of the opening portion becomes almost flat at the same height as the surface of the reflector.

16. A planar light source device, wherein a luminous device mounting package as defined in claim 14 is installed on the bottom face of the chassis.
